(19) United States
(12) Patent Application Publication
(10) Pub. No.: US 2025/0378408 A1
(43) Pub. Date: Dec. 11, 2025

(54) FINOPS GOVERNANCE MATURITY ASSESSMENT WITH A MULTI-CLOUD GOVERNANCE PLATFORM

(71) Applicants: SABAPATHY ARUMUGAM, Seattle, WA (US); SATYABRAT CHOWDHURY, Seattle, WA (US); KAMALA KANNAN SOMASUNDARAM, Chennai (IN)

(72) Inventors: SABAPATHY ARUMUGAM, Seattle, WA (US); SATYABRAT CHOWDHURY, Seattle, WA (US); KAMALA KANNAN SOMASUNDARAM, Chennai (IN)

(21) Appl. No.: 19/205,998

(22) Filed: May 12, 2025

Related U.S. Application Data
(60) Provisional application No. 63/645,340, filed on May 10, 2024.

(51) Int. Cl. G06Q 10/0637; G06Q 10/04

(52) U.S. Cl. CPC G06Q 10/0637; G06Q 10/04

(57) ABSTRACT

In one aspect, a method for assessing FinOps governance maturity in a multi-cloud environment is presented. The method begins with onboarding a cloud account to a multi-cloud governance platform. Following onboarding, the method involves pulling resources, resource utilizations, resource costs, budget data, and cloud provider recommendations from the cloud account. Next, a set of predefined policies is executed on the resources to identify optimization recommendations for each of the resources. Based on these optimization recommendations, a maturity score for the cloud account is calculated. The method then generates a FinOps governance maturity assessment report comprising the maturity score and the optimization recommendations. Finally, the FinOps governance maturity assessment report is provided to a user interface for display to the user.

### CLAIM OF PRIORITY

This application claims priority to U.S. Provisional Patent Application No. 63/645,340, and filed on May 10, 2024. This provisional patent application is hereby incorporated by references in its entirety.

### BACKGROUND

### Field of the Invention

The present invention relates generally to cloud computing resource management, and more particularly to systems and methods for assessing and optimizing cloud expenditure through a FinOps Governance Maturity Assessment framework implemented across multi-cloud environments.

### Description of the Related Art

Organizations increasingly deploy workloads across multiple cloud providers, resulting in complex environments with numerous accounts managed by different teams. This distributed approach to cloud resource management creates significant challenges in maintaining consistent governance, especially regarding cost optimization and financial operations (FinOps).

Current cloud platforms offer basic cost management tools, but these solutions are typically limited to their specific environments and lack comprehensive governance frameworks that span multiple cloud providers. Additionally, existing tools often provide recommendations without contextualizing them within a broader maturity assessment model that can guide organizations toward systematic improvement.

Organizations operating in multi-cloud environments face several critical challenges:

Inconsistent governance practices across different cloud accounts and teams, leading to variations in cost efficiency and resource utilization.

Limited visibility across cloud services, regions, and resource tags, making it difficult to detect spending anomalies and optimization opportunities.

Inability to track maturity progress over time, preventing organizations from measuring improvements in their cloud governance practices.

Lack of standardized assessment methodologies that incorporate multiple dimensions of FinOps governance, including resource right-sizing, configuration optimization, idle resource management, and scheduling optimization.

Absence of automated, scalable assessment models that can continuously evaluate cloud accounts at regular intervals and on-demand.

Cloud resource waste remains a persistent problem, with significant financial implications. Underutilized resources, improper configurations, idle or orphaned resources, and inefficient scheduling collectively contribute to unnecessary expenditure. Organizations require comprehensive solutions that can not only identify these inefficiencies but also evaluate their overall maturity in addressing these issues systematically.

Existing solutions typically focus on individual cost-saving recommendations without providing a holistic assessment framework that measures an organization's governance capabilities. This gap prevents organizations from understanding their relative maturity and establishing clear, actionable improvement paths across their cloud environments.

A comprehensive FinOps Governance Maturity Assessment system is therefore needed to establish standardized evaluation criteria, provide visibility across multi-cloud environments, generate detailed recommendations, and track improvement over time through quantifiable maturity scores. Such a system would enable organizations to systematically enhance their cloud governance practices and optimize their cloud expenditure through continuous assessment and improvement.

### SUMMARY OF THE INVENTION

In one aspect, a method for assessing FinOps governance maturity in a multi-cloud environment is presented. The method begins with onboarding a cloud account to a multi-cloud governance platform. Following onboarding, the method involves pulling resources, resource utilizations, resource costs, budget data, and cloud provider recommendations from the cloud account. Next, a set of predefined policies is executed on the resources to identify optimization recommendations for each of the resources. Based on these optimization recommendations, a maturity score for the cloud account is calculated. The method then generates a FinOps governance maturity assessment report comprising the maturity score and the optimization recommendations. Finally, the FinOps governance maturity assessment report is provided to a user interface for display to the user.

### BRIEF DESCRIPTION OF THE DRAWINGS

FIG. 1 illustrates an example process for providing FinOps governance maturity assessment, according to some embodiments.

FIG. 2 illustrates an example process for providing strategies to optimize resource utilization, according to some embodiments.

FIG. 3 illustrates an example process to establish and iterate actions for efficient governance with a for multi-cloud platform, according to some embodiments.

FIG. 4 illustrates another example process for FinOps Governance Maturity Assessment, according to some embodiments.

FIG. 5 illustrates an example system, according to some embodiments.

FIG. 6 illustrates an example for providing cost-spend visibility and/or cost optimization recommendations into FinOps governance maturity assessment reports, according to some embodiments.

FIG. 7 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for FinOps governance maturity assessment with a multi-cloud governance platform. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Amazon Web Services, Inc. (AWS) is an on-demand cloud computing platform(s) and API( )s. These cloud-computing web services can provide distributed computing processing capacity and software tools via AWS server farms. AWS can provide a virtual cluster of computers, available all the time, through the Internet. The virtual computers can emulate most of the attributes of a real computer, including hardware central processing units (CPUs) and graphics processing units (GPUs) for processing; local/RAM memory; hard-disk/SSD storage; a choice of operating systems; networking; and pre-loaded application software such as web servers, databases, and customer relationship management (CRM).

Microsoft Azure (e.g. Azure as used herein) is a cloud computing service operated by Microsoft for application management via Microsoft-managed data centers. It provides software as a service (Saas), platform as a service (PaaS) and infrastructure as a service (IaaS) and supports many different programming languages, tools, and frameworks, including both Microsoft-specific and third-party software and systems.

Cloud computing architecture refers to the components and subcomponents required for cloud computing. These components typically consist of a front-end platform (fat client, thin client, mobile), back-end platforms (servers, storage), a cloud-based delivery, and a network (Internet, Intranet, Intercloud). Combined, these components can make up cloud computing architecture. Cloud computing architectures and/or platforms can be referred to as the ‘cloud’ herein as well.

Cloud resource model (CRM) provides ability to define resource characteristics, Hierarchy, dependencies, and its action in a declarative model and embed them in Open API specification. CRM allows both humans and computers to understand and discover capabilities and characteristics of cloud service and its resources.

Containerization is operating system-level virtualization or application-level virtualization over multiple network resources so that software applications can run in isolated user spaces called containers in any cloud or non-cloud environment, regardless of type or vendor. Containers can be fully functional and portable cloud or non-cloud computing environment surrounding the application and keeping it independent of other parallelly running environments. Individually each container simulates a different software application and runs isolated processes by bundling related configuration files, libraries and dependencies. Multiple containers can share a common operating system kernel (OS). Containerization has been adopted by cloud computing platforms like, inter alia: Amazon Web Services, Microsoft Azure, Google Cloud Platform, and IBM Cloud.

Hyperscalers can be large cloud service providers. Hyperscalers can be the owners and operators of data centers where these horizontally linked servers are housed.

Multi-cloud refers to a company utilizing multiple cloud computing services from various public vendors within a single, heterogeneous architecture. This approach can enhance cloud infrastructure capabilities and optimizes costs. It can also refer to the distribution of cloud assets, software, applications, etc. across several cloud-hosting environments.

### EXAMPLE SYSTEMS AND METHODS

A multi-cloud governance platform is provided that empowers enterprises to rapidly achieve autonomous and continuous cloud governance and compliance at scale. Multi-cloud governance platform is delivered to end users in the form of multiple product offerings, bundled for a specific set of cloud governance pillars based on the client's needs. Example multi-cloud governance platform's offerings and associated cloud governance pillars are now discussed.

The multi-cloud governance platform can provide FinOps as a solution offering that is designed to help an entity develop a culture of financial accountability and realize the benefits of the cloud faster. The multi-cloud governance platform SecOps as a solution offering designed to help keep cloud assets secure and compliant. The multi-cloud governance platform is a solution offering designed to help optimize cloud operations and cost management in order to provide accessibility, availability, flexibility, and efficiency while also boosting business agility and outcomes. The multi-cloud governance platform provides a Well-Architected Assessment functionality (e.g. CoreStack Assessments®, etc.) that is designed to help an entity adopt best practices according to well-architected frameworks, gain continuous visibility, and manage risk of cloud workloads with assessments, policies, and reports that allow an administrator to review the state of applications and get a clear understanding of risk trends over time.

Well-Architected Assessment functionality helps enterprises adopt cloud best practices, manage risk, and maintain reliable, secure, resilient, cost-efficient, performant, and sustainable cloud infrastructures.

Cloud Governance Pillars that can be implemented by the multi-cloud governance platform are now discussed. The multi-cloud governance platform can enable governing of cloud assets involves cost-efficient and effective management of resources in a cloud environment while adhering to security and compliance standards. There are several factors that can be involved in a successful implementation of cloud governance. The multi-cloud governance platform has encompassed all these factors into its cloud governance pillars. The following table explains the key cloud governance pillars developed by Multi-cloud governance platform.

Cloud trail (e.g. using AWS CloudTrail as an example) can be a service that helps enable operational and risk auditing, governance, and compliance of an AWS account. Actions taken by a user, role, or an AWS service are recorded as events in the cloud trail service. Events can include various actions taken, inter alia in the: AWS Management Console, AWS Command Line Interface, and AWS SDKs and APIs.

The multi-cloud governance platform utilizes various operations that provide the capability to operate and manage various cloud resources efficiently and effectively using various features such as automation, monitoring, notifications, activity tracking.

The multi-cloud governance platform utilizes various security operations that enable management of the security governance of various cloud accounts and identify the security vulnerabilities and threats and resolve them.

The multi-cloud governance platform utilizes various manages cost. The multi-cloud governance platform enables users to create a customized controlling mechanism that can control a customer's cloud expenses within budget and reduce cloud waste by continually discovering and eliminating inefficient resources.

The multi-cloud governance platform utilizes various access operations. The multi-cloud governance platform utilizes various allows administrators to configure secure access of resources in a cloud environment and protect the users' data and assets from unauthorized access.

The multi-cloud governance platform utilizes various resource management operations. The multi-cloud governance platform enables users to define, enforce, and track the resource naming and tagging standards, sizing, and their usage by region. It also enables a customer to follow consistent and standard practices pertaining to resource deployment, management, and reporting.

The multi-cloud governance platform utilizes various compliance actions. The multi-cloud governance platform guides users to assess a cloud environment for its compliance status against standards and regulations that are relevant to an organization-ISO, NIST, HIPAA, PCI, CIS, FedRAMP, AWS Well-Architected framework, and custom standards.

The multi-cloud governance platform utilizes various self-service operations. The multi-cloud governance platform enables administrators to configure a simplified self-service cloud consumption model for end users that are tied to approval workflows. It enables an entity to automate repetitive tasks and focus on key deliverables.

The multi-cloud governance platform continuously assesses the state of the customer's cloud workloads against well-architected frameworks to manage risk and embrace best practices. These best practices can be provided across certain ‘pillars’ (e.g. cost, security, operations, security, sustainability, etc.). The multi-cloud governance platform includes a Well-Architected Assessment functionality that designed to help adopt best practices, gain continuous visibility, and manage risk for cloud workloads with assessments, policies, and reports that allow a customer to review the state of a customer's applications and get a clear understanding of risk trends over time. Further, it automatically discovers issues and provides actionable insights for remediation, simplifying and streamlining the process of assessing, improving, and maintaining cloud workloads. The multi-cloud governance platform can onboard cloud accounts and manage workloads. In this way, the multi-cloud governance platform supports well-architected frameworks (WAF).

The Well-Architected Assessment functionality helps ensure user workloads are optimized as part of a strong cloud strategy in the following key areas: automate discovery and remediate at scale discovering issues across best practice areas for user cloud workloads can be difficult and time-consuming, which is why the multi-cloud governance platform implements auto-discovery and remediation features. This helps improve user productivity for detecting any issues in a cloud account or workloads and provides those insights for a user to look into and remediate at scale. The Well-Architected Assessment functionality can enable collaboration with multiple teams and enable gathering information and collecting evidence for best practices can present challenges around collaboration. Since it's usually not a single person doing the assessment, but a group of people across different teams, the multi-cloud governance platform provides built-in collaboration features to make assessing user workloads easier. The Well-Architected Assessment functionality can be used to validate across multi-cloud workloads. The multi-cloud governance platform helps make it possible to validate best practices across multiple clouds by providing a single pane of glass to do a well-architected review across diverse workloads. The multi-cloud governance platform also supports a multi-cloud well architected framework for workloads that span across more than one cloud provider. The Well-Architected Assessment functionality can classify best practices. Cloud best practices can fall into multiple categories. As part of the Well-Architected Assessment functionality, the multi-cloud governance platform provides built-in pillars respective to each cloud platform (AWS, Azure, etc.) that organize best practices into relevant areas of focus, such as operations, security, sustainability, and more. The multi-cloud governance platform include these pillars to helps users clearly define which areas they need to focus on and guide a user in terms of next steps to move towards a well-architected cloud infrastructure.

The Well-Architected Assessment functionality can enable map policies to workloads best practices for different cloud platforms are reinforced in the multi-cloud governance platform by built-in policies, which are mapped directly to various best practices. These policies help identify any violations in a workload based on a particular best practice. Policies come pre-loaded and pre-mapped, but a user can also create and map a customer's policies. This enables a user to validate user workloads against best practices with more ease and control. Automate best practices even with built in best practice classification and policies, validating user workloads against best well-architected frameworks can still require manual work.

The multi-cloud governance platform the Well-Architected Assessment functionality maps relevant policies to identify violations against certain best practice and can automate most of the work needed to validate user workloads and identify any violations, reducing the amount of overhead and effort needed on a user. Built-in suggestions for remediation can be provided. For many of The multi-cloud governance platform's automated policies, any identified violations that appear as part of an assessment will come with a suggested remediation to address it. These suggestions appear directly to the user in the multi-cloud governance platform web portal, making it easy to both find and fix any issues with user cloud workloads.

Built-in evidence tracking is provided. The multi-cloud governance platform can keep track of what steps were taken to implement best practices and address any violations is a key part of the cloud optimization process. The multi-cloud governance platform the Well-Architected Assessment functionality can simplify and streamline this part of the process by providing built-in comment and file attachment features for each best practice item included in an assessment. Users can add evidence directly in the assessment to show what was done to meet certain best practices, as well as create a milestone once an assessment is complete to log a snapshot of a workload that can be referenced later.

Clear assessment workflow is implemented by the multi-cloud governance platform. Progress through assessments with ease with a built-in workflow that helps the user to follow each step of the assessment process and account for each best practice item along the way. The multi-cloud governance platform can start an assessment, go through the questions, remediate any violations it finds, then reach a finishing point where an administrator is ready to create a milestone. Export assessment reports In addition to being able to monitor user assessment results directly in the multi-cloud governance platform web portal, results can be exported as reports (e.g. PDF or image file). This makes it easy to share the results of an assessment with other members of a team, or across departments.

The multi-cloud governance platform can integrate with AWS Well-Architected (WA). The multi-cloud governance platform the Well-Architected Assessment functionality supports one-directional integration with AWS Well-Architected, meaning it can send data directly from The multi-cloud governance platform to AWS. When a user completes an assessment, whatever best practices the user provides answers can be synced to AWS so that results show there as well. This is helpful for keeping information consistent across both The multi-cloud governance platform and AWS environments. The multi-cloud governance platform's mission is to not only help with assessing cloud posture, but to provide a clear path to realizing well-architected workloads.

### FinOps Governance Maturity Assessment

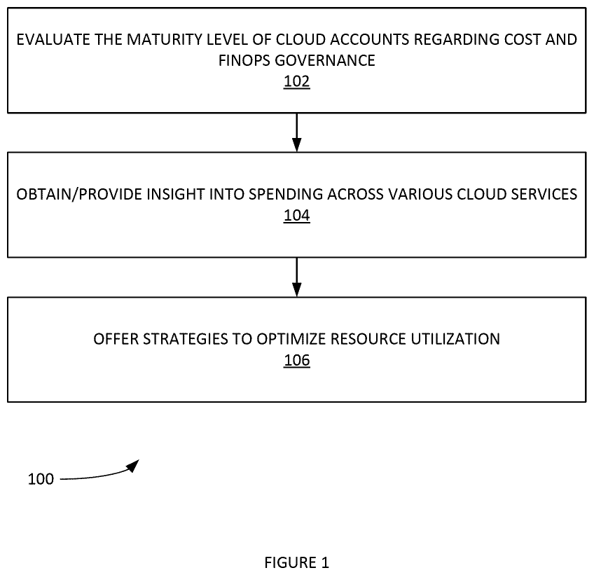

FIG. 1 illustrates an example process 100 for providing FinOps governance maturity assessment, according to some embodiments. It is noted that cloud governance involves establishing policies, procedures, and controls to effectively manage and enhance the utilization of cloud resources within an organization.

In step 102, process 100 evaluates the maturity level of cloud accounts regarding cost and FinOps governance. This assessment is centered around optimizing cloud expenditure through the monitoring of resource consumption, identification of cost-saving opportunities, and implementation of budgetary constraints.

In step 104, process 100 obtains/provides insight into spending across various cloud services. In step 106, based on the output of step 104, process 100 can offer strategies to optimize resource utilization. These insights can be obtained by process 200.

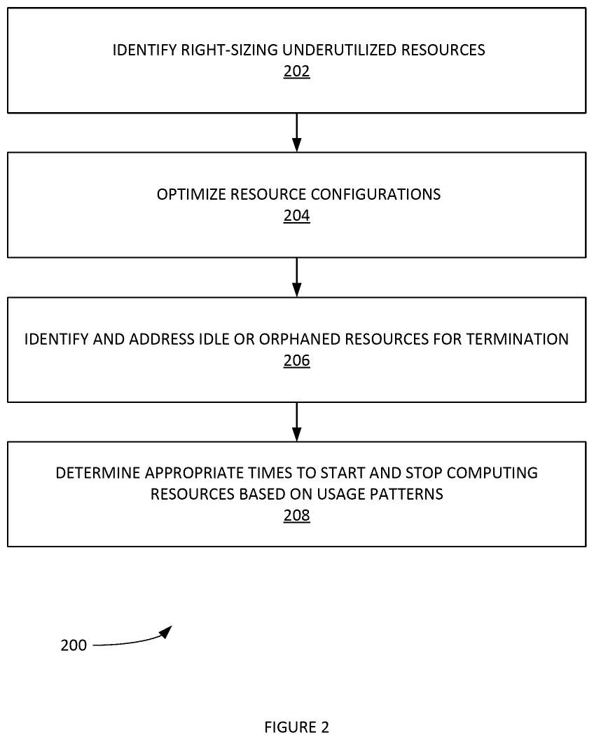

FIG. 2 illustrates an example process 200 for providing strategies to optimize resource utilization, according to some embodiments. In step 202, process 200 can identify right-sizing underutilized resources. In step 204, process 200 can optimize resource configurations. In step 206, process 200 can identify and address idle or orphaned resources for termination. In step 208, process 200 can determine the appropriate times to start and stop computing resources based on usage patterns.

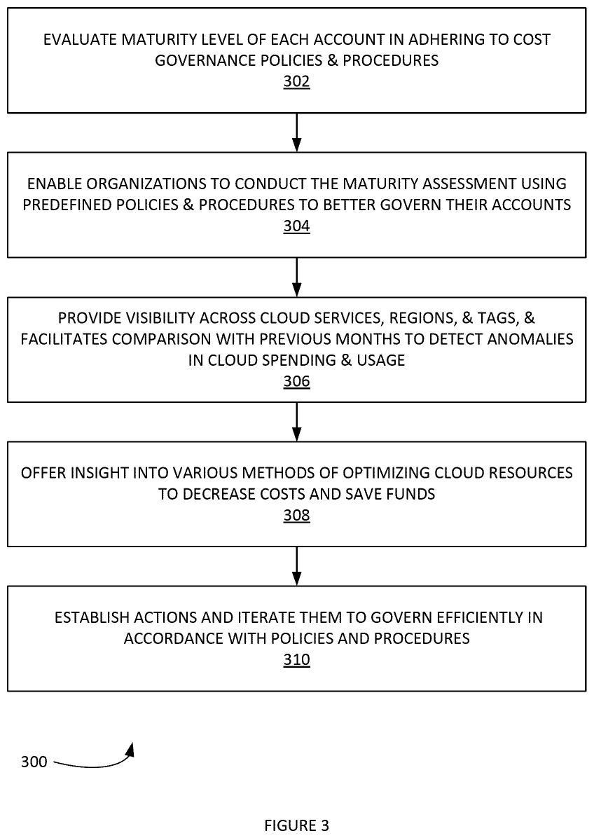

FIG. 3 illustrates an example process 300 to establish and iterate actions for efficient governance with a for multi-cloud platform, according to some embodiments. It is noted that each organization/entity can operate multiple cloud accounts. Each of the multiple cloud accounts can be managed and utilized by different teams as well. Consequently, cloud governance concerning cost and FinOps may vary from one account to another and from team to team. The FinOps Governance Maturity Assessment provided herein can evaluate the maturity level of each account in adhering to cost governance policies and procedures 302. This can enable teams to act upon recommendations and enhance their maturity score.

In step 304, process 300 can enable organizations to conduct the maturity assessment using predefined policies and procedures to better govern their accounts. This assessment provides visibility across cloud services, regions, and tags, and thus, facilitates comparison with previous months to detect anomalies in cloud spending and usage in step 306. In step 308, process 300 can offer insight into various methods of optimizing cloud resources to decrease costs and save funds. By comparing the maturity levels of different cloud accounts, organizations can establish actions and iterate them to govern efficiently in accordance with policies and procedures in step 310.

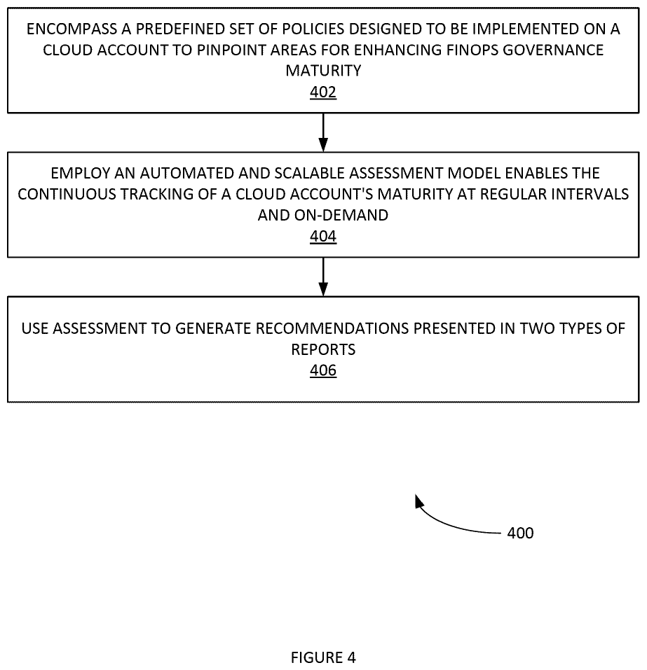

FIG. 4 illustrates another example process 400 for FinOps Governance Maturity Assessment, according to some embodiments. In step 402, process 400 encompasses a predefined set of policies designed to be implemented on a cloud account to pinpoint areas for enhancing FinOps governance maturity.

In step 404, process 400 employs an automated and scalable assessment model enables the continuous tracking of a cloud account's maturity at regular intervals and on-demand. In step 406, process 400 uses the assessment to generate recommendations presented in two types of reports. The first type of report is the Executive Summary Report. This report delivers a concise overview of visibility, recommendations, and operational guidelines for managing a cloud account effectively.

The second type of report is the detailed recommendation report. This report furnishes detailed insights at the level of cloud services and policies. It includes a list of resources that could benefit from optimization, such as right-sizing, configuration enhancements, identification of idle or orphaned resources, and scheduling recommendations. Additionally, it outlines the potential cost savings achievable by implementing these recommendations.

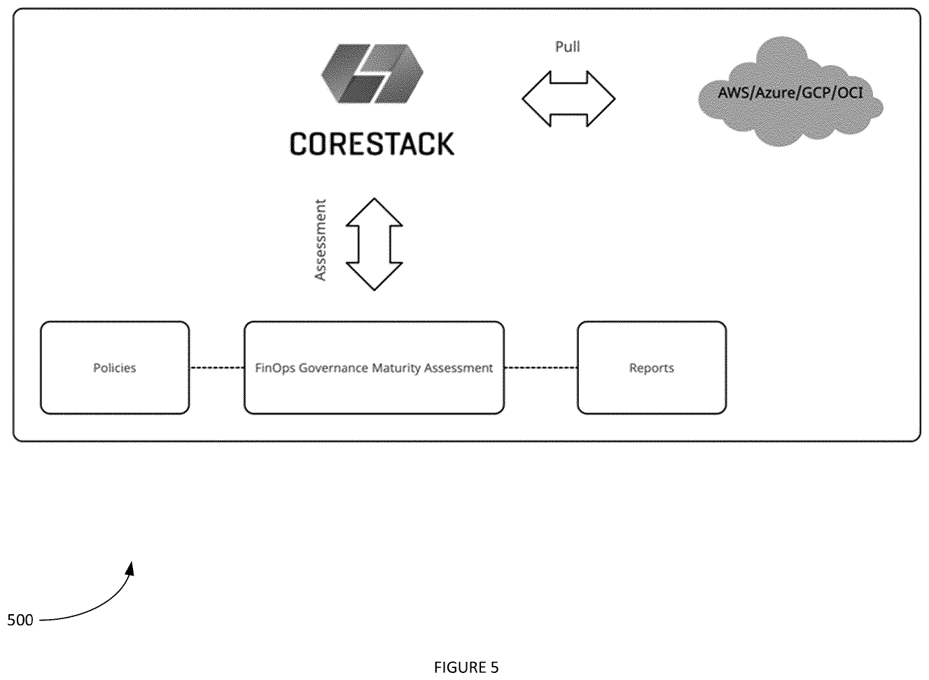

FIG. 5 illustrates an example system 500, according to some embodiments. System 500 can offer a diverse range of cost optimization suggestions sourced from both cloud providers and the multi-cloud governance platform. This can be accompanied by a maturity score for assessment and the capability to compare scores with past evaluations. The governance maturity assessment provides a summary tailored for CXOs, while delivering a detailed report aimed at procurement, engineering, and FinOps teams within the organization.

The multi-cloud governance platform policies extend coverage across cloud services, surpassing the recommendations typically offered by cloud providers. Adhering to FinOps best practices as defined by FinOps.org, the approach encompasses various facets of informing, optimizing, and operating for continual governance and enhancement.

More specifically, the multi-cloud governance platform (e.g. Corestack, etc.) can pull specified information available hyperscalers. This can include resources utilized by the applications, application utilizations, budgets, cost usage reports, other billing information, inventory discovery of client accounts, etc. These can be combined, and an assessment is the performed on the pulled data.

The assessment can generate a FinOps governance maturity assessment. In this way, system 500 can be used for FinOps governance mature assessment. The assessment analyses how a cloud account is performing with respect to informing/optimizing/operating cost. The output can be viewed in the form of a report where it provides insights and visibility on each of these three aspects. System 500 can assess various onboarded cloud accounts periodically to identify any violations and generate a FinOps Maturity Assessment Report. This assessment is performed against specific assessment scenarios, each having its own definition and weight. The assessment analyzes how each cloud account is performing with respect to controlling costs. Cost control identifies whether resources are managed within defined budget thresholds. Cost optimization checks if any resources are used in an optimized manner. The assessment also includes details around recommendations and cost avoidance. Based on the number of violated resources per scenario, a maturity index is derived. This maturity index helps an administrator understand how a cloud account is performing over a set time period.

A cloud account can be configured with the required privileges prior to onboarding the cloud account in order to perform a FinOps Maturity Assessment. Read-only access to most services can be sufficient for the FinOps Maturity Assessment in some examples.

System 500 provides a comprehensive FinOps Maturity Assessment Report for cloud accounts. A customer can view the assessment score for their cloud account that is identified based on the resources assessed. Cost avoidance is estimated for each of the assessment categories in a cloud account.

Cloud administrators can perform an assessment of their cloud accounts to view the governance index and compare them against each other to see where they stand according to others in industry benchmarks. An administrator can generate an automated assessment report every month to visualize the improvements/decline in the index.

Score=((100−% of Potential Cost Savings)0.5)+((100−% of Violated Resources)0.1)+((100−% of Budget Violations)0.2)+((100−% of Untagged Resources)0.2)

% Of Potential Cost Savings=((Potential Cost Savings)/Average Monthly Cost)*100)

% Of Violated Resources=(Total Violated Resources/Total Resources Assessed)*100%

Of Budget Violations=(Total Violated Budget Scenarios/Total Budget Scenarios Assessed)*100

System 500 can provide a defined set of assessment scenarios based on a cloud platform, cloud services, and cloud resource types that are available in a cloud account. These assessment scenarios are based on Industry Standards and Best Practices, including those recommended by AWS, Azure, and GCP. There are scenarios available for each Governance Pillar: Operations, Security, Cost, Access, and Resource Consistency.

System 500 checks the status of a cloud environments against these standards for each of the 5 pillars and provides a consolidated report that covers multiple aspects of various cloud accounts. For example, an Operations assessment will include checks for multiple aspects such as Monitoring, Utilization, Activities, Automation, Backup, Patching, etc. Similarly, each pillar will have all their key areas covered as part of the assessment.

System 500 checks for the compliance percentage across various resources for each assessment scenario. Each scenario carries a certain weight based on how critical that is. An Assessment Score is provided for a cloud account by calculating the weighted average of the results across all scenarios.

System 500 can also schedule recommendations. These can be cost saving recommendations focusing on when a resource can be stopped by identifying when they are idle whether it is a specific hours in a day or specific day in a week. These recommendations are generated based on utilization metrics using ML algorithms. System 500 can perform a resource view of cost optimization recommendations. Example types of recommendations can include, inter alia: Right Sizing, Idle, Orphaned, Configuration, Schedule Recommendations, etc. for a resource and providing a visibility to the user to decide.

System 500 can provide cost usage reports. An example of a cost usage report is in Appendix A of U.S. Provisional Patent Application 63/645,340 incorporated herein by reference. An administrator can select the required cloud account and view its report(s).

System 500 can provide Assessment Reports. Assessment reports can provide a detailed FinOps Maturity Assessment Report for specific Governance Pillars and Cloud Accounts. The report summary provides information about each assessment scenario for the selected cloud account, as well as an overall score for the account and the Governance Pillar. This helps to understand the specific areas where the account requires improvements and recommend any necessary next steps. The fields available in the Assessment Summary section are, inter alia: Assessment Sub-Category, Assessment Group, Assessment Scenario, Total Violated Resources, Total Resources Assessed, Potential Cost Avoidance, etc.

The report can be printed or exported in PDF and Excel file formats. While in the report, an administrator can switch between different Tenants, Cloud Accounts, and Assessment Dates to view the report and export one.

The Assessment Detail section provides a deeper view into the assessment results. An administrator can view the number of violated resources and total number of resources assessed for each of the assessment scenarios.

The fields available in the Assessment Detail section are, inter alia: Description, Resource Type/Resource, Total Resources Assessed, Number of Violated Resources, Total Estimated Monthly Cost Avoidance, Recommendations, etc.

The actual resources that are in violation are also listed after each Assessment Category. This helps the cloud administrator to identify the actual resources in violation so they can take immediate action to resolve them.

In one example, the FinOps Maturity Assessment Report contains the following sections:
FinOps Assessment: This section provides an overview of the FinOps maturity level of a cloud account;
FinOps Assessment Summary: This section summarizes the information identified for different FinOps assessment scenarios for a cloud account, and are grouped based on the categories;
FinOps Assessment Detail: This section provides further details for each resource involved in the FinOps Maturity Assessment and provides associated information to remediate any resource violations in a cloud account;
Cost Visibility: This section provides an overview of the actual costs incurred by resources against their forecasted costs;
Cost Insights: This section presents insights on various factors such as regions and tags that are available on a chosen cloud platform; and
Assessment Visibility: This section provides a summary of the resources that are involved in the assessment.

Visibility and Insights are captured as a snapshot and persist once the assessment is completed. This helps an administrator to relate cost avoidance, resources, and other details together. Point-in-time data for costs can be available only in the Posture and Other Cost Reports section.

Recommendations related to reservations are provided as part of the AWS management account that's consolidated for all the AWS member accounts.

It is noted that some aspects of system 500 can be configurable to set thresholds for detecting various anomalies.

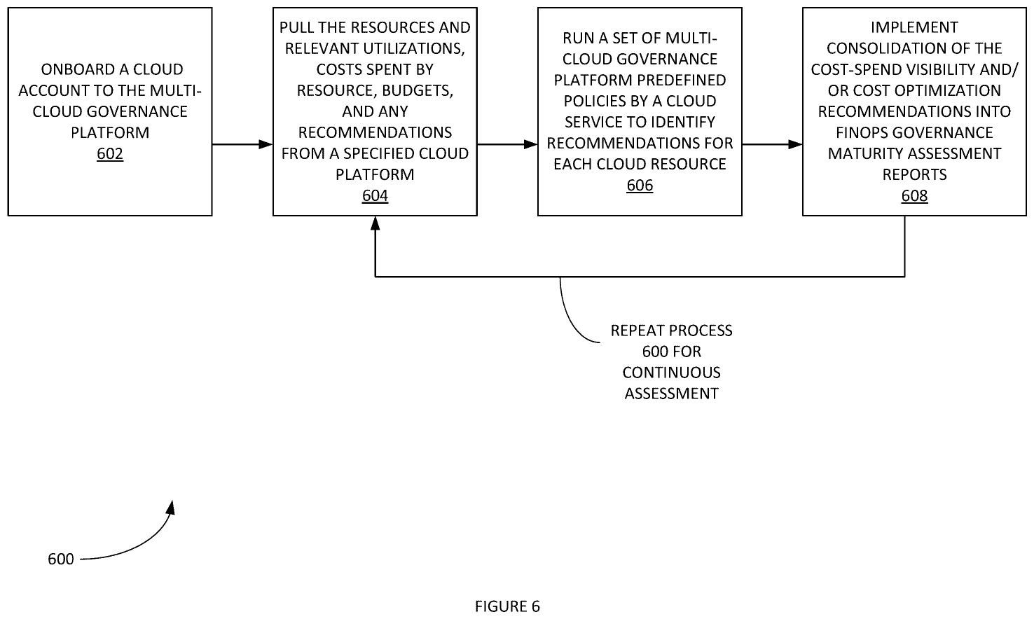

FIG. 6 illustrates an example for providing cost-spend visibility and/or cost optimization recommendations into FinOps governance maturity assessment reports, according to some embodiments. In step 602, process 600 can onboard a cloud account to the multi-cloud governance platform. In step 604, process 600 can pull the resources and relevant utilizations, costs spent by resource, budgets, and any recommendations from a specified cloud platform. In step 606, process 600 can run a set of multi-cloud governance platform predefined policies by a cloud service to identify recommendations for each cloud resource. In step 608, process 600 can implement consolidation of the cost-spend visibility and/or cost optimization recommendations into FinOps governance maturity assessment reports. These reports can be summaries and/or detailed.

Cloud cost anomaly is now discussed. Cloud cost anomaly can refers to unexpected or abnormal variations in the cost of cloud services. Anomalies can be detected if the daily spend is either too high or too low. A cost anomaly is detected through the billing data provided by the cloud provider. Cost Anomalies detected will have a cost impact (−ve/+ve impact) which denotes the impact caused by product category/region/resource category/resource. Cost Anomaly can be because of the following:
Unexpected Usage Demand/Pattern: Changes in usage patterns, such as more traffic from a different geographical region which leads to unexpected increase in data transfer, which can have an impact on cloud spend;
Poor Workload Management: Over-provisioning or leaving unused resources running and inefficient resource allocation can result in unnecessary expenses;
Third-Party Services: Integration with third-party services or applications may introduce additional costs that were not initially accounted for;
Software Bugs or Glitches: Bugs or glitches in cloud management software or automation scripts can inadvertently lead to increased cloud spending;
Security Incidents: Security breaches or unauthorized access to cloud resources can result in unexpected charges, especially if resources are used maliciously; and
Rate Changes: Changes in cloud service pricing or billing models by the cloud provider can impact overall costs.

### Additional Example Computer Architecture and Systems

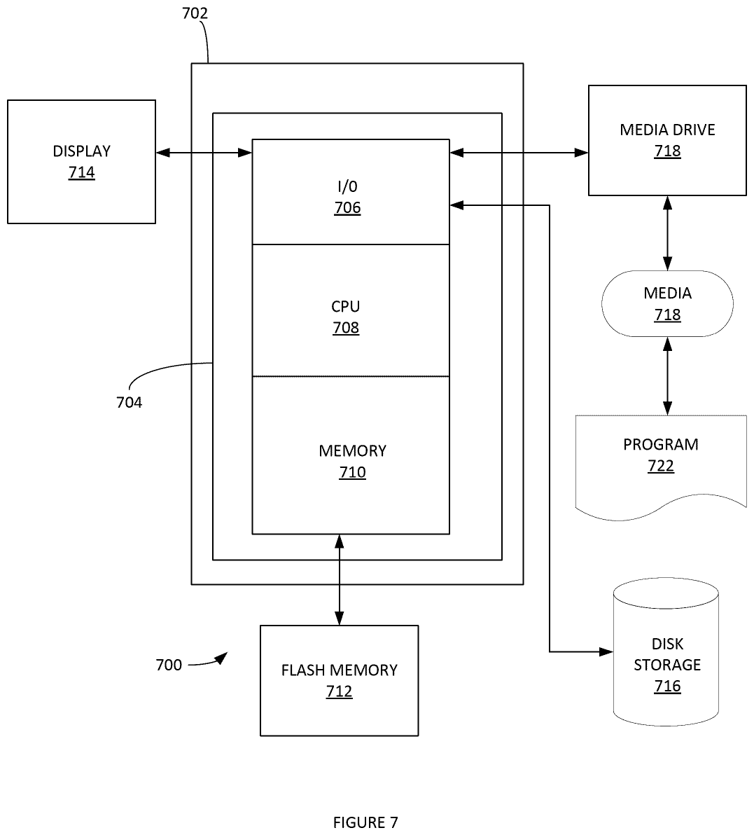

FIG. 7 depicts an exemplary computing system 700 that can be configured to perform any one of the processes provided herein. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A method for assessing FinOps governance maturity in a multi-cloud environment, the method comprising:
onboarding a cloud account to a multi-cloud governance platform;
pulling resources, resource utilizations, resource costs, budget data, and cloud provider recommendations from the cloud account;
executing a set of predefined policies on the resources to identify optimization recommendations for each of the resources;
calculating a maturity score for the cloud account based on the optimization recommendations;
generating a FinOps governance maturity assessment report comprising the maturity score and the optimization recommendations; and
providing the FinOps governance maturity assessment report to a user interface for display.

2. The method of claim 1, wherein executing the set of predefined policies on the resources comprises:
identifying underutilized resources for right-sizing based on resource utilization metrics;
identifying resource configuration optimizations based on resource configuration data;
identifying idle or orphaned resources for termination based on resource utilization metrics; and
determining appropriate scheduling for starting and stopping computing resources based on resource usage patterns.

3. The method of claim 1, further comprising:
calculating potential cost savings for each of the optimization recommendations; and
including the potential cost savings in the FinOps governance maturity assessment report.

4. The method of claim 1, wherein calculating the maturity score for the cloud account comprises:
determining a percentage of potential cost savings relative to average monthly cost;
determining a percentage of violated resources relative to total resources assessed;
determining a percentage of budget violations relative to total budget scenarios assessed;
determining a percentage of untagged resources; and
calculating the maturity score using a weighted formula incorporating the percentage of potential cost savings, the percentage of violated resources, the percentage of budget violations, and the percentage of untagged resources.

5. The method of claim 1, wherein the FinOps governance maturity assessment report comprises: an executive summary report providing a concise overview of visibility, recommendations, and operational guidelines; and a detailed recommendation report providing insights at a level of cloud services and policies.

6. The method of claim 1, further comprising:
conducting periodic assessments of the cloud account at predetermined intervals;
storing historical maturity scores from the periodic assessments; and
including a comparison of current and historical maturity scores in the FinOps governance maturity assessment report.

7. The method of claim 1, further comprising:
detecting cost anomalies in the cloud account by comparing current spending patterns with historical spending patterns;
identifying root causes of the cost anomalies; and
including the cost anomalies and the root causes in the FinOps governance maturity assessment report.

8. The method of claim 1, wherein the FinOps governance maturity assessment report comprises visualizations of: average monthly cost versus potential cost savings; cost visibility and savings by top services; cost visibility and savings by top resources; cost savings by top tags; and cost savings by assessment category.

9. The method of claim 1, further comprising:
establishing configurable thresholds for cost anomaly sensitivity, idle thresholds, and right-size thresholds;
utilizing the configurable thresholds when executing the set of predefined policies on the resources; and
allowing a user to modify the configurable thresholds through the user interface.

10. The method of claim 1, further comprising:
consolidating optimization recommendations from multiple sources including cloud provider native recommendations and the multi-cloud governance platform recommendations;
ranking the optimization recommendations based on potential cost savings or impact; and
providing remediation actions for implementing the optimization recommendations in the FinOps governance maturity assessment report.
